(19) United States
(12) Patent Application Publication
(10) Pub. No.: US 2026/0080652 A1
(43) Pub. Date: Mar. 19, 2026

(54) OBJECT DETECTION DEVICE, OBJECT DETECTION METHOD, AND OBJECT DETECTION PROGRAM

(71) Applicant: NTT, Inc., Tokyo (JP)

(72) Inventors: Yuko IINUMA, Tokyo (JP); Saki HATTA, Tokyo (JP); Hiroyuki UZAWA, Tokyo (JP); Shuhei YOSHIDA, Tokyo (JP); Yuya OMORI, Tokyo (JP); Yusuke HORISHITA, Tokyo (JP); Daisuke KOBAYASHI, Tokyo (JP); Ken NAKAMURA, Tokyo (JP)

(73) Assignee: NTT, Inc., Tokyo (JP)

(21) Appl. No.: 18/992,437

(22) PCT Filed: Jul. 13, 2022
(86) PCT No.: PCT/JP2022/027593

§ 371 Date: Jan. 8, 2025

(51) Int. Cl. G06V 10/25; G06T 5/30

(52) U.S. Cl. CPC G06V 10/25; G06T 5/30; G06V 2201/07

(57) ABSTRACT

Object detection with high accuracy can be realized while maintaining a constant processing speed even in a limited environment of resources.

An object detection device includes a rectangle extraction unit that extracts a plurality of rectangles to be candidates to which object detection is applied from an input image, a rectangle selection unit that selects a fixed number of rectangles to which the object detection is applied from among the rectangle candidates extracted from the rectangle extraction unit, and an object detection unit that performs the object detection on the rectangle selected by the rectangle selection unit to output metadata including at least a class, reliability, and a bounding box of the object included in the input image as an object detection result.

### TECHNICAL FIELD

The disclosed technique relates to an object detection device, an object detection method, and an object detection program.

### BACKGROUND ART

Conventionally, there is a technique related to an object detection device. The object detection device is a device of estimating a class (person, automobile, etc.) of an object included in an inputted image, a bounding box, and reliability. The bounding box is rectangular coordinate information surrounding the object.

In recent years, a plurality of object detection models using deep learning has been proposed. As the object detection model based on the deep learning, YOLO (You Only Look Once) and RetinaNet of collectively inferring bounding boxes and object classes have been proposed (see NPL 1 and NPL 2). In addition, as the object detection model, R-CNN for separately detecting candidate regions of objects and classifying classes, and Faster R-CNN for improving the same have been proposed (see NPL 3 and NPL 4). When the object detection model based on the deep learning first appeared, it was computationally expensive and took a long time for inference, but by improving the learning method and the structure of the neural network, an inference speed has been greatly improved and the inference accuracy has also been improved.

In addition, there have been proposed several methods for realizing the object detection from high-definition images and video by dividing images. For example, a method has been proposed in which an image group divided equally in accordance with the input size of the object detection model and an image reduced as a whole are inputted to the object detection model, respectively (see NPL 5). In this technique, the coordinate information of the obtained bounding box is scaled, and detection results of the divided and reduced images are synthesized to output the final result. Also, a means has been proposed in which object distribution is estimated by using density estimation or cluster detection, and the object detection model is applied by dividing the image on the basis of the object distribution (see NPL 6 and NPL 7).

### CITATION LIST

### Non Patent Literature

[NPL 1] J. Redmon et al., “You Only Look Once: Unified, Real-Time Object Detection”, 2016 IEEE Conference on Computer Vision and Pattern Recognition (CVPR), 2016, pp. 779-788.

[NPL 2] T.-Y. Lin et al., “Focal Loss for Dense Object Detection”, 2017 IEEE International Conference on Computer Vision (ICCV), 2017, pp. 2999-3007.

[NPL 3] R. Girshick et al., “Rich Feature Hierarchies for Accurate Object Detection and Semantic Segmentation”, 2014 IEEE Conference on Computer Vision and Pattern Recognition, 2014, pp. 580-587.

[NPL 4] S. Ren et al., “Faster R-CNN: Towards Real-Time Object Detection with Region Proposal Networks”, in IEEE Transactions on Pattern Analysis and Machine Intelligence, vol. 39, No. 6, pp. 1137-1149, 1 Jun. 2017.

[NPL 5] H. Uzawa et al., “High-definition object detection technology based on AI inference scheme and its implementation”, IEICE Electronics Express, 2021, Volume 18, Issue 22, Pages 20210323.

[NPL 6] C. Li et al., “Density Map Guided Object Detection in Aerial Images”, 2020 IEEE/CVF CVPRW, 2020, pp. 737-746.

[NPL 7] F. Yang et al., “Clustered Object Detection in Aerial Images”, 2019 IEEE/CVF ICCV, 2019, pp. 8310-8319.

### SUMMARY OF INVENTION

### Technical Problem

As a conventional means of performing object detection from high-definition video as described above, a method of performing the object detection without dividing the image, and a method of applying the object detection to each divided image by dividing the image are disclosed. The means of dividing the image is further divided into a means of equally dividing the image and a means of adaptively dividing the image.

In the means of equally dividing the image, the division number is very large in high-definition video, so that there is a problem that a large error occurs in the synthesis of results. In addition, although the means of performing adaptive division may have a possibility of greatly reducing the division number of the image depending on a scene, the division number becomes the same as the case of equal division depending on the image, there is a possibility that all the divided images cannot be processed within a desired processing time, and accuracy of the detection result may have a possibility to be declined. This problem appears remarkably in a limited environment of calculation resources such as an edge terminal, in particular.

The disclosed technique has been made in view of the above-mentioned points, and an object thereof is to provide an object detection device, an object detection method, and an object detection program that can realize the object detection with high accuracy while maintaining a constant processing speed even in the limited environment of resources.

### Solution to Problem

An object detection device according to a first aspect of the present disclosure includes a rectangle extraction unit that extracts a plurality of rectangles to be candidates to which object detection is applied from an input image, a rectangle selection unit that selects a fixed number of rectangles to which the object detection is applied from among the rectangle candidates extracted from the rectangle extraction unit, and an object detection unit that performs the object detection on the rectangle selected by the rectangle selection unit to output metadata including at least a class, reliability, and a bounding box of the object included in the input image as an object detection result.

An object detection method according to a second aspect of the present disclosure causes a computer to perform processing of extracting a plurality of rectangles to be candidates to which object detection is applied from an input image, selecting a fixed number of rectangles to which the object detection is applied from among the extracted rectangle candidates, and performing the object detection on the selected rectangle to output metadata including at least a class, reliability, and a bounding box of the object included in the input image as an object detection result.

An object detection program according to a third aspect of the present disclosure causes a computer to perform processing of extracting a plurality of rectangles to be candidates to which object detection is applied from an input image, selecting a fixed number of rectangles to which the object detection is applied from among the extracted rectangle candidates, and performing the object detection on the selected rectangle to output metadata including at least a class, reliability, and a bounding box of the object included in the input image as an object detection result.

### Advantageous Effects of Invention

According to the disclosed technique, object detection with high accuracy can be realized while maintaining a constant processing speed even in a limited environment of resources.

### BRIEF DESCRIPTION OF DRAWINGS

FIG. 1A is a configuration diagram of processing of equally dividing an image and performing object detection.

FIG. 1B is a configuration diagram of a method of adaptively dividing the image by object distribution estimation.

FIG. 2 is a block diagram showing a hardware configuration of an object detection device.

FIG. 3 is a block diagram showing a configuration of the object detection device of a first embodiment.

FIG. 4 is a block diagram showing a hardware configuration of the object detection device.

FIG. 5 is a flowchart showing a flow of object detection processing performed by the object detection device.

FIG. 6 is a detailed flow of the case where a means using a detection result of a past frame is applied to rectangle selection processing.

FIG. 7 is a diagram showing an example in which an input image is equally divided into four sections and this cyclic means is applied.

FIG. 8 is a block diagram showing a configuration of an object detection device 200 of a second embodiment.

FIG. 9 is a flowchart for the case where the thinning judgement is performed in a fixed time.

FIG. 10 is a flowchart for the case where the thinning judgement is performed by detecting a decrease in the object detection number.

FIG. 11 is a flowchart for the case where the thinning judgement is performed by combining the fixed time and the means of the detection number.

FIG. 12 is a flowchart of processing for the case where a movement of rectangle is predicted.

FIG. 13 is an example for processing an inputted frame by using a pipelined processing flow.

### DESCRIPTION OF EMBODIMENTS

Hereinafter, an example of embodiments of the disclosed technique will be described with reference to the drawings. Note that, in each drawing, the same or equivalent constituent components and portions are denoted by the same reference numerals. Further, dimensional ratios in the drawings are exaggerated for convenience of description, and may differ from actual ratios.

First, a technique which is a premise of a proposed technique in a present disclosed embodiment and an overview of the present embodiment will be described.

In an object detection model listed in the conventional technique, improvement of the model progresses, and detection accuracy is improved, so that movement of applying AI inference technique including object detection to industrial fields such as automatic driving and IoT becomes active. The AI inference technique is roughly classified into a cloud AI and an edge AI depending on whether inference is performed on a cloud or a terminal.

The cloud AI is provided by a service such as a GCP (Google Cloud Platform), an AWS (Amazon Web Service), and a Microsoft Azure. The cloud AI performs inference processing such as object detection by using a large-scale calculation resource on a server having a GPU (Graphics Processing Unit) mounted thereon. On the other hand, in the edge AI, the inference processing is performed on a device such as a smart phone or a drone located at an end of a network. Since calculation resources such as a memory size and processor performance are limited compared with the cloud AI, the edge AI is not suitable for execution of a large-scale AI inference model.

However, it is possible to suppress the cost required for communication by minimizing the exchange of information via the Internet, and there is a great merit from the viewpoint of security measures and cost reduction. Research and development have been progressed in which the edge AI is applied to automatic driving, crime prevention, quality assurance and safety management in a manufacturing site by utilizing this characteristic. The object detection is widely used in such applications and constitutes a core of AI inference techniques. For example, the edge AI is applied to an application for monitoring and tracking a person, an automobile, and the like by the object detection by mounting a small camera and a processor on a monitoring camera and a drone.

Conventionally, although the camera mounted on the edge terminal is not so high in resolution, the drone and the monitoring camera mounted with a 4K camera are generally used as a camera sensor is made compact and high in performance, and a smart phone and a drone mounted with a high-definition 8K camera have recently appeared. Therefore, it is considered that a demand of a device capable of performing the object detection from such high-definition video is increased in the future. However, many object detection models have fixed input sizes and cannot process high-definition images as they are. For example, the input size of the object detection model of YOLO v3 is about 500 to 1500 pixels. Some object detection models employing FCN (Fully Convolutional Network) can be used as a variable input size. Therefore, even a high-definition image such as 8K can be inputted as it is or with a declined reduction ratio. However, as the input image is made to be high-definition, an intermediate feature amount is made large in capacity and a model itself is made large in scale, and particularly, on the edge terminal where calculation resources are limited, it is not realistic to directly perform the object detection from the high-definition image. In view of this, there has been proposed a method of realizing the object detection from high-definition images and video by dividing images as listed in NPL 5 to NPL 7. Hereinafter, (1) a means of equally dividing the image and (2) a means of adaptively dividing the image will be described, respectively.

### (1) Means of Equally Dividing Image (Conventional Means 1)

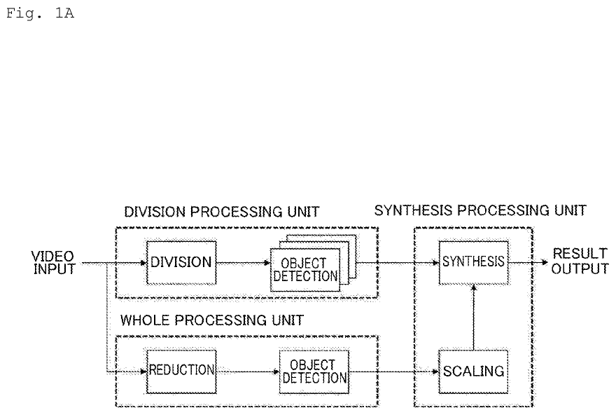

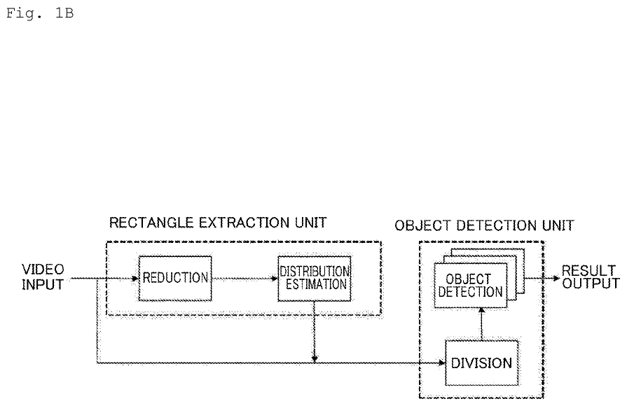

FIG. 1A is a configuration diagram of processing of equally dividing the image and performing the object detection. The configuration diagram of this processing is a means of NPL 5, for example. The configuration of the conventional means 1 is configured by a division processing unit, a whole processing unit, and a synthesis processing unit. The division processing unit equally divides the image and performs the object detection from each divided image. On the other hand, the whole processing unit reduces the whole image and applies the object detection. Finally, the synthesis processing unit synthesizes a result obtained by the division processing unit and a result obtained by scaling a result obtained by the whole processing unit in accordance with the image size before reduction, and outputs a final object detection result. When performing the object detection from a 4K (3840×2160) image by using a YOLO v3 having an input image size of 608×608 by this means, the division number is 28 divisions. On the other hand, in the case of 8K (7680×4320), the division number becomes very large as 112 divisions, which are four times the division number, and the calculation amount in the division processing unit becomes huge. In addition, the boundary of the division requiring the synthesis of the bounding box is increased, and the number of objects to be cut is also increased. Then, errors in the synthesis processing unit are accumulated, and the accuracy of object detection to be finally outputted is declined.

### (2) Means of Equally Dividing Image (Conventional Means 2)

FIG. 1B is a block diagram of a method of adaptively dividing the image by object distribution estimation. The configuration of the conventional means 2 is configured by two functional units of a rectangle extraction unit and an object detection unit. First, in the rectangle extraction unit, an inputted image is reduced, and the object distribution estimation is performed by density estimation or cluster detection. Then, based on a result, a region (rectangle) to which the object detection is applied is determined in accordance with the object distribution. The object detection unit cuts out the above-described rectangle from the inputted image, and applies the object detection to each of them. Since the rectangle is cut out in accordance with the object distribution, cutting of the object caused when the equal division means is applied hardly occurs. On the other hand, there is a possibility that the division number of the image changes greatly depending on the object distribution. In a scene where the objects are unevenly distributed in a part of the image, the division number may be suppressed to a minimum of 1, but in the worst case, the division number is the same as that of the equal division, and the reduction effect of the calculation amount cannot be obtained. When the division number of the image is increased in this way, the object detection may not be completed within a desired processing time in a limited environment with calculation resources such as an execution environment of the edge AI.

In addition, in the object detection means by the equal division of the conventional means 1, there are problems that the calculation amount is increased with the increase of the division number and the accuracy is declined due to the cutting of the object. Among these, although the accuracy decline due to cutting of the object is relaxed by the adaptive division, the calculation amount is not always reduced. That is, there is a problem that it is difficult to reduce rectangles to which the object detection is applied to a certain number and suppress an increase in the calculation amount while suppressing a decline in the object detection accuracy.

The means of the present embodiment is designed to solve the above-described problems. In the means of the present embodiment, a priority degree score is calculated from information such as object density and past frames for a plurality of rectangles extracted by the rectangle selection unit and the rectangles are narrowed down to a fixed number, so that the number of rectangles to which the object detection is applied is reduced. Thus, the object detection can be executed within a predetermined processing time while suppressing decline of the object detection accuracy even in a limited environment of calculation resources such as an edge terminal.

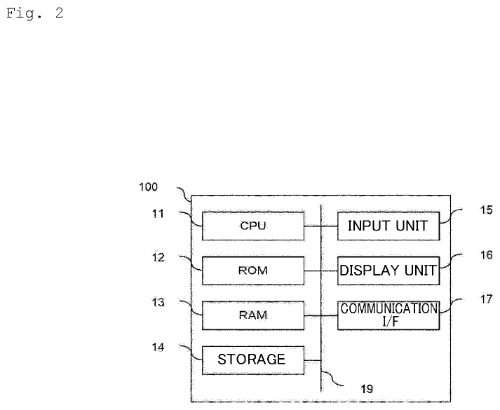

Hereinafter, a configuration of the present disclosed embodiment will be described. FIG. 2 is a block diagram showing a hardware configuration of an object detection device 100.

As shown in FIG. 2, the object detection device 100 has a CPU (Central Processing Unit) 11, a ROM (Read Only Memory) 12, a RAM (Random Access Memory) 13, a storage 14, an input unit 15, a display unit 16, and a communication interface (I/F) 17. The constituent components are communicatively connected to each other via a bus 19.

The CPU 11 is a central arithmetic processing unit, and executes various programs or controls each unit. That is, the CPU 11 reads the program from the ROM 12 or the storage 14 and executes the program by using the RAM 13 as a work region. The CPU 11 performs control of above-described each configuration and various types of arithmetic processing in accordance with the programs stored in the ROM 12 or the storage 14. In the present embodiment, an object detection program is stored in the ROM 12 or the storage 14.

The ROM 12 stores various programs and various types of data. The RAM 13 temporarily stores the program or data as the work region. The storage 14 is constituted by a storage device such as an HDD (Hard Disk Drive) or an SSD (Solid State Drive), and stores various programs including an operating system and various types of data.

The input unit 15 includes a pointing device such as a mouse or a keyboard, and is used for various inputs.

The display unit 16 is, for example, a liquid crystal display, and displays various types of information. The display unit 16 may employ a touch panel scheme, and may function as the input unit 15.

The communication interface 17 is an interface of performing communication with other equipment such as the terminal. For such communication, for example, a wired communication standard such as Ethernet (registered trademark) or FDDI, or a wireless communication standard such as 4G, 5G, or Wi-Fi (registered trademark) is used.

### First Embodiment

Next, each functional configuration of the object detection device 100 according to a first embodiment will be described.

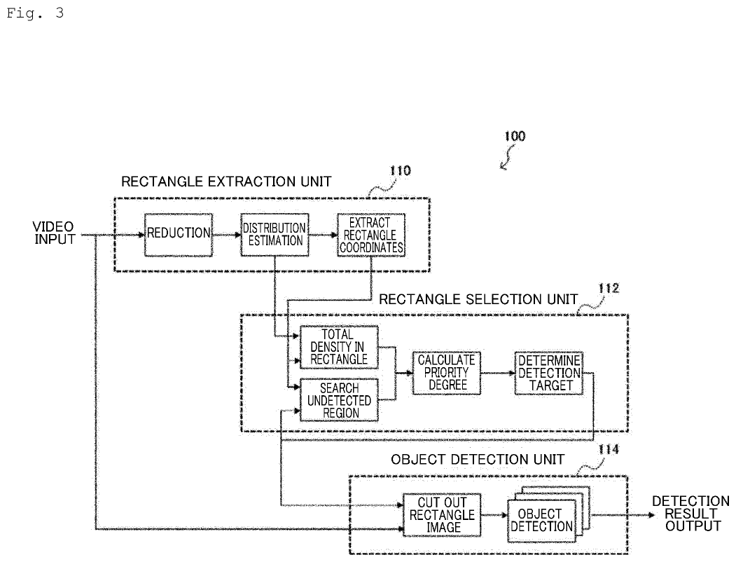

FIG. 3 is a block diagram showing a configuration of the object detection device of the present embodiment. The respective function configurations are realized when the CPU 11 reads the object detection program stored in the ROM 12 or the storage 14 and develops the read program on the RAM 13 to execute it.

FIG. 3 shows a configuration diagram of the object detection device 100 which realizes the first embodiment. As shown in FIG. 3, the object detection device 100 is configured to include a rectangle extraction unit 110, a rectangle selection unit 112, and an object detection unit 114. The object detection device 100 receives a series of input images as video input as an input, and executes processing of each unit for each received input image.

The first embodiment is similar to the conventional means 2 in that the image is adaptively divided in accordance with the object distribution to perform the object detection. However, the present invention is different in that a rectangle selection unit of selecting the rectangle to which the object detection is applied is newly provided.

The rectangle extraction unit 110 extracts a plurality of rectangles (hereinafter referred to simply as candidate rectangles) to be candidates by performing the object distribution estimation. The input image is reduced to a fixed size, and a region where the object exists is estimated as an input image distribution by using a deep learning model such as object detection and cluster detection. When the density estimation is used for estimating the distribution, a region in which the density distribution equal to or more than a preset value is obtained is cut out, extracted as a rectangle candidate of an object detection target, and coordinate information is acquired. When the cluster detection is used, coordinates of a cluster in which objects are dense and reliability are estimated by using the deep learning model, and a cluster whose reliability is equal to or more than a fixed value is extracted as the candidate rectangle.

The rectangle selection unit 112 selects a rectangle to which the object detection is applied by using the result of density estimation and the rectangle selected in the past frame from among the candidate rectangles extracted by the rectangle extraction unit 110. For the selection, priority degree is calculated from a density score s_{density} and an overlap degree score sᵢₒᵤ for each of the N rectangles obtained by the rectangle extraction unit 110, and the rectangle selection is performed in accordance with the ranking of the priority degree. The details of the selection means will be described later in the description of the flow.

Finally, the object detection unit 114 applies the object detection model to the rectangle selected by the rectangle selection unit 112, respectively, and outputs a final object detection result. Here, an arbitrary model can be selected as the object detection model. Note that the object detection result is outputted as metadata including at least a class, reliability, and a bounding box of the object included in the input image.

In the present embodiment, the rectangle selection method is a method of selecting a rectangle to which the object detection is applied by using the result of density estimation and the rectangle selected in the past frame, but the method is not limited to this, and a means of using the detection result of the past frame, a means of using an image difference, a means of cyclically selecting the rectangle, or a means of combining these means may be employed.

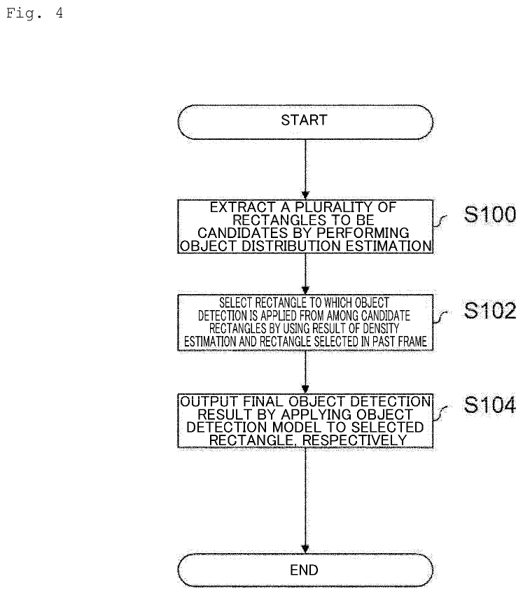

Next, operations of the object detection device 100 will be described. FIG. 4 is a flowchart showing a flow of the object detection processing by the object detection device 100. The object detection processing is performed when the CPU 11 reads the object detection program from the ROM 12 or the storage 14 and develops the program on the RAM 13 to execute it.

In step S100, the CPU 11 extracts the plurality of rectangles to be candidates by performing the object distribution estimation as the rectangle extraction unit 110.

In step S102, the CPU 11 selects the rectangle to which the object detection is applied by using the result of density estimation and the rectangle selected in the past frame from among the candidate rectangles obtained by the rectangle extraction unit 110 as the rectangle selection unit 112.

In step S104, the CPU 11 applies the object detection model to the rectangle selected by the rectangle selection unit 112 as the object detection unit 114, respectively, and outputs the final object detection result.

Next, a detailed flow of the rectangle selection processing of the rectangle selection unit in step S102 will be described. The selection means includes a means of using the result of density estimation, a means of using the detection result of the past frame, a means of selecting the rectangle on the basis of the image difference, and a means of dividing the input image into the plurality of sections and selecting the rectangle included in the section while cyclically selecting the section.

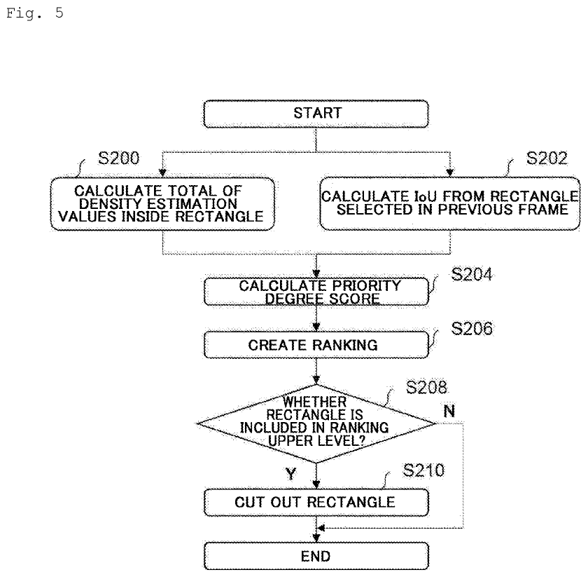

Among them, the means of using the result of density estimation and the means of using the detection result of the past frame will be described by using the flow. A detailed flow in the case where the means of using the result of density estimation is applied to the rectangle selection processing in step S102 will be described with reference to FIG. 5. Note that each of the extracted rectangles is processed.

In step S200, first, density values inside the rectangle extracted in the current frame are summed up to calculate the density score S_{density}. In the density estimation, a density estimation value d_{x, y} is assigned to pixels at positions (x, y) on the input image. A set of pixel coordinates (x, y) included in a certain extracted rectangle Rᵢ (i=1, . . . N) is defined as Rᵢ (in the case of a subscription in the formula, it is also represented as Ri), the density score of a certain rectangle is given by S_{density}=Σ_{(x, y)Ri}d_{x, y}.

Next, in step S202, the overlap degree (IoU: Intersection over Union) between the rectangle selected in the past frame and the rectangle Rᵢ extracted from the current frame is calculated, and the overlap degree score sᵢₒᵤ is calculated. When two rectangles whose areas are a₁ and a₂ are given, respectively, the IoU can be calculated by aᵢₙₜₑᵣ/(a₁+a₂−aᵢₙₜₑᵣ) by using the area aᵢₙₜₑᵣ of the overlapped portion. This value is calculated for each pair with the rectangle selected in the past frame, and the maximum value is defined as the overlap degree score sᵢₒᵤ of the rectangle Rᵢ.

In step S204, a priority degree score s_{priority} is calculated from the obtained density score and the overlap degree score. In this case, in order to preferentially select a rectangle extracted from the region which has not been detected so far or a rectangle having a high object density, a calculation is performed as follows, s_{priority}=−λsᵢₒᵤ+s_{density} or s_{priority}=1/ sᵢₒᵤ+λs_{density}. Where, λ is a parameter for calculating a weighted sum, and may be a coefficient of either sᵢₒᵤ or s_{density}, or may be multiplied as each coefficient like λ₁ or λ₂.

In step S206, ranking is created in order from the highest priority degree score.

In step S208, it is judged whether or not the rectangle is included in a ranking upper level. When it is included in the upper level, the rectangle is cut out in step S210, and when it is not included in the upper level, the processing is ended. The rectangles are sequentially selected from the upper level so that the rectangle number is a predetermined number of rectangles in consideration of the application and the hardware configuration of the device. This rectangle selection method is a method of applying the object detection to a region where the object detection has not been applied so far in addition to a region where the detection number in which the objects are dense is expected to be large. In this way, the rectangle selection unit 112 can use a means of selecting a rectangle on the basis of the overlap degree between the distribution estimation result obtained from the rectangle extraction unit 110 and the rectangle selected in the past input image.

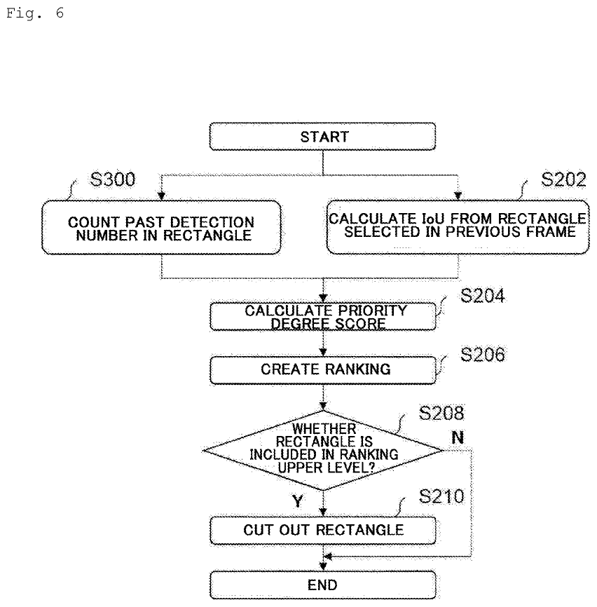

Next, the means of using the detection result of the past frame will be described. A detailed flow in the case of applying the means using the detection result of the past frame to the rectangle selection processing in step S102 will be described with reference to FIG. 6. Note that, since only step S200 is different from the flow of FIG. 5, only that point will be described as step S300.

In the means of using the detection result of the past frame, the detection number of objects is counted to compute the priority degree score s_{priority}. In the computation of the priority degree score s_{priority}, not only the rectangle selected in the past frame but also the coordinates of the detected object are recorded. In addition, in step S300 of the computation, the above-described calculation of the density score s_{density} is computed by counting the object number detected from the past frame in the rectangle and replacing it with the calculation of the object number score s_{obj_num}. In this case, for a while after the input of the video is started, the rectangle selection and object detection are performed with s_{obj_num} set to 0 at the time of calculating the priority degree score, and the object coordinates of the whole image are grasped. As the period in which s_{obj_num} is set to 0, an arbitrary frame number may be set in advance, or an arbitrary number of times may be repeated until there is no rectangle in which s_{obj_num} is set to 0, or until the rectangle number becomes equal to or less than a fixed number. In addition, for the rectangle to which the object detection is applied, coordinate information of the object detection result of a corresponding region on the input frame is updated. This method is suitable for an application where the detection number of objects is important. In this way, the rectangle selection unit 112 can use a means of selecting the rectangle based on the object detection result obtained from the past input image.

In the means of using the image difference, the priority degree is determined based on the difference between the immediately preceding frame and the current frame. First, each frame image is converted from a color image of RGB format into a gray scale. Thereafter, the difference in pixel units is taken, and a difference image with its absolute value as a pixel value is generated. The difference image is cut out on the basis of the coordinates of the rectangle obtained from the current frame, and the total of the pixel values is calculated to obtain the priority degree score s_{priority}. That is, the object detection is preferentially applied to a rectangle having the large image difference caused by the movement of the object. This method is suitable for an application for detecting a moving object such as a traveling automobile or a walking person. In this way, the rectangle selection unit 112 can use a means of selecting a rectangle based on the image difference from the past input image.

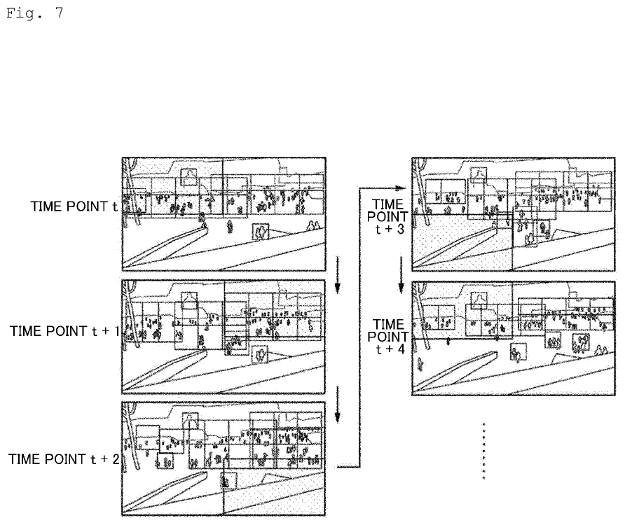

In a means of cyclically selecting the rectangle, for example, an image is divided into N sections, and rectangle included in a certain section is preferentially selected. Further, the section whose priority degree is set high is cyclically set, the section is changed in which the section 1 is prioritized at time point t and the section N is prioritized at time point t+N−1, and the section is returned the section 1 at time point t+N. The determination method of the section in this method is optional, and the section may be set equally or the section may be set unequally depending on the scene. For example, FIG. 7 shows an example in which an input image is equally divided into four sections and this cyclic means is applied.

In this example, the section which is located at the upper left at time point t and selects the rectangle preferentially moves in each section to time point t+3, and returns to the upper left of the original section at time point t+4. The method is suitable for evenly detecting the whole image, and is useful in such a scene that the movement of the object is not so intense and the objects are distributed over the whole image. In this way, the rectangle selection unit 112 can use a means of dividing the input image into the plurality of sections and selecting the rectangle included in the section while cyclically selecting the section.

The above-mentioned rectangle selection method is not exclusive to each other, and may be used in combination in some cases. For example, a combination of generating ranking by adding the value of the image difference as a difference value score s_{diff} to the priority degree score s_{priority} is considered, but the combination of the rectangle selection methods is not limited to this.

By processing the image in such a method, the application of object detection is always narrowed down to a fixed number of rectangles in the rectangle selection unit 112, so that the problem in which the division number is increased and the calculation amount is increased can be solved. By such an effect, the object detection with high accuracy can be realized while maintaining the constant processing speed even in the limited environment of resources such as an edge terminal.

As described above, according to the object detection device 100 of the present embodiment, it is possible to realize the object detection with high accuracy while maintaining the constant processing speed even in the limited environment of resources.

### Second Embodiment

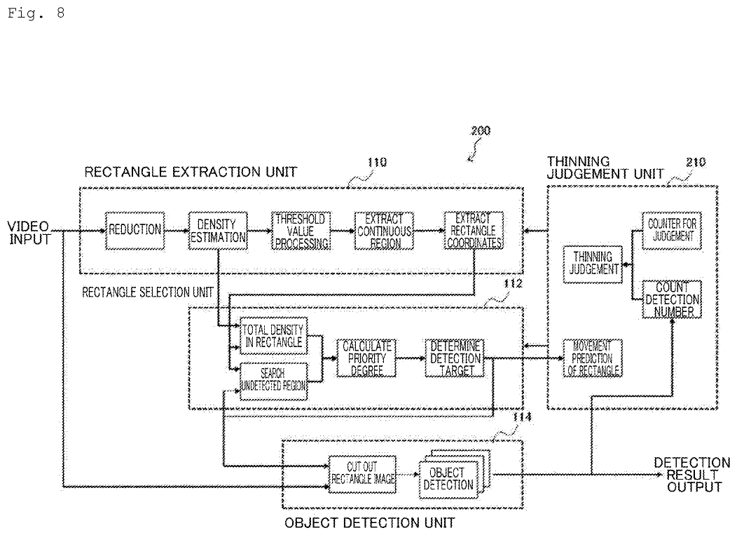

FIG. 8 shows a configuration example of an object detection device 200 of a second embodiment. In the object detection device 200 of the second embodiment, in addition to the three processing units shown in the first embodiment, a thinning judgement unit 210 is newly introduced, and it is judged whether or not the rectangle extraction and the rectangle selection are performed, that is, whether or not the thinning judgement of the processing of the rectangle extraction unit 110 and the rectangle selection unit 112 is performed. The thinning is to omit the processing for obtaining the rectangles of the rectangle extraction unit 110 and the rectangle selection unit 112. The thinning judgement unit 210 judges whether or not the processing is performed in the rectangle extraction unit 110 and the rectangle selection unit 112 by a predetermined method. Then, the thinning judgement unit 210 applies the rectangle obtained by executing the processing of the rectangle extraction unit 110 and the rectangle selection unit 112 in the previously inputted frame to the current frame and thins out the processing.

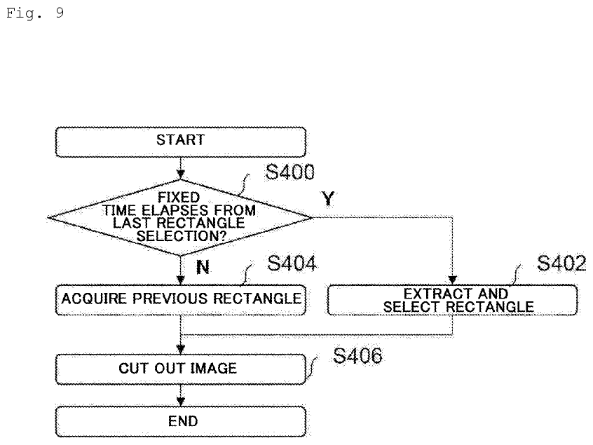

FIG. 9 is a flowchart showing the case where the thinning judgement is performed in a fixed time. In step S400, it is judged whether or not the fixed time has elapsed after the last rectangle selection. When the fixed time has elapsed, the processing shifts to step S402, and when the fixed time have not elapsed, the processing shifts to step S404. In this thinning judgement, an interval for extracting and selecting the rectangle is set in advance as a Hyperparameter in accordance with a scene to which the object detection is applied. When the fixed time elapses, the rectangle is extracted and selected once (step S402). Then, until the fixed time designated as the interval elapses, the rectangle extraction unit 110 and the rectangle selection unit 112 are notified so as to thin out the processing by acquiring the previously selected rectangle and performing the object detection (step S404). In this case, the processing and output of the rectangle extraction unit 110 and the rectangle selection unit 112 are temporarily stopped and thinned out, and the previously selected rectangle is used in the processing of the object detection unit 114. Since it is not necessary to assign the calculation resources for extraction and selection of rectangles including distribution estimation by the thinning processing, the object detection can be applied to more rectangles by applying the calculation resources to the processing of the object detection unit 114, and improvement of detection accuracy can be expected. In this way, the thinning judgement unit 210 can use the means of realizing the thinning processing by not executing the processing of the rectangle extraction unit and the rectangle selection unit for the fixed time set in advance.

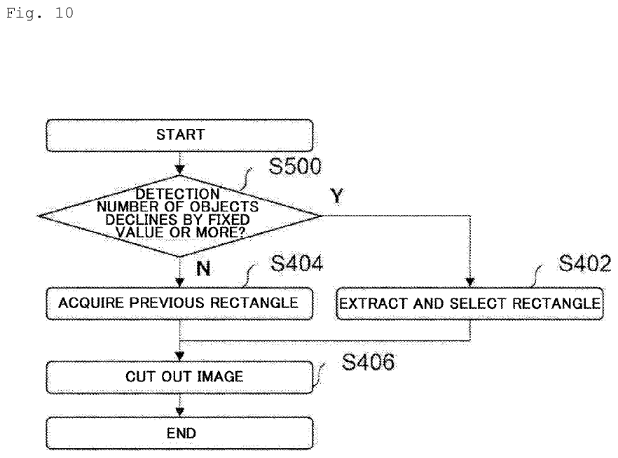

In the above-mentioned example, although the thinning judgement is performed at the fixed time interval, the thinning judgement may be performed by detecting a decrease in the object detection number as shown in a flowchart of FIG. 10 (step S500). In this method, when the detection number of objects in the subsequent frames is decreased by a certain value or more with reference to the detection number of objects in the frame in which the rectangle is extracted and selected, the rectangle is extracted and selected again in the next frame. For this reason, a threshold value of a decrease rate of the object detection number is set as the Hyperparameter. In this way, the thinning judgement unit 210 can use a means of thinning out the processing by thinning out the processing of the rectangle extraction unit 110 and the rectangle selection unit 112 until the object detection number in a predetermined frame becomes equal to or less than a fixed rate in comparison with the detection number of objects in the frame in which the rectangle is extracted and selected.

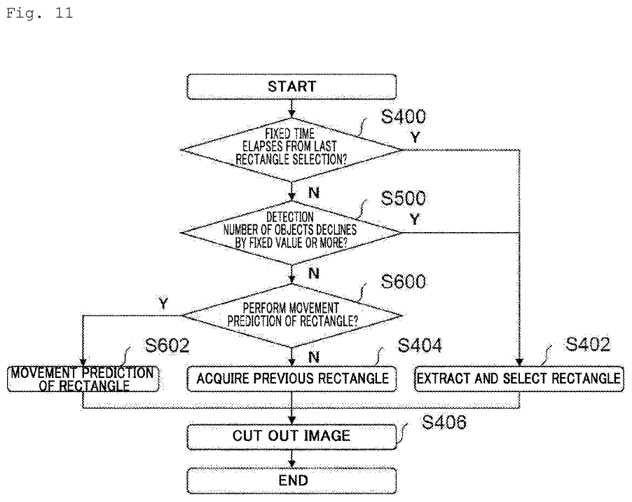

In addition, the thinning judgement may be performed by combining the above-described methods (step S400 and step S500). FIG. 11 is a flowchart showing the case where the thinning judgement is performed by combining a fixed time and a means of the detection number. For example, a combination is considered in which a long cycle interval for forcibly extracting and selecting the rectangle is set and the rectangle is extracted and selected when the detection number of objects is declined among the intervals. In any of the above-mentioned means, in the frame in which the rectangle is not extracted and selected, the rectangle selected in the previous frame may be used as it is, or the coordinates of the rectangle to be cut out from the frame may be moved by predicting the movement of the rectangle. The prediction may be appropriately determined in accordance with a decline in the detection number.

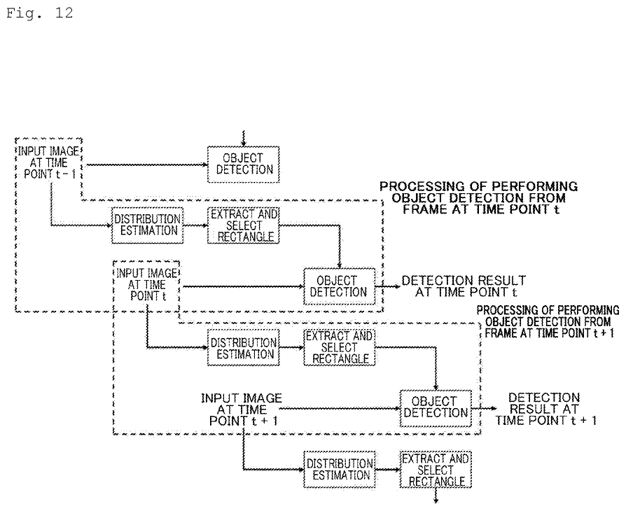

FIG. 12 shows a flowchart of processing of the case where the movement of the rectangle is predicted. In step S600, it is judged whether or not the movement of the rectangle is predicted. When the prediction is performed, the processing shifts to step S602, and when the prediction is not performed, the processing shifts to step S404. When the movement prediction of the rectangle is performed, the extraction and selection of the rectangle are performed from continuous frame for a fixed period, and the movement prediction of the rectangle is performed on the basis of the result (step S602). The prediction method may be linear interpolation or may use an algorithm such as SORT with higher accuracy.

Each judgement unit in the flowchart and the movement prediction of the rectangle are performed by the thinning judgement unit 210 of the configuration diagram shown in FIG. 8, and the processing of acquiring the previous rectangle and extracting and selecting the rectangle is performed by the rectangle extraction unit 110 and the rectangle selection unit 112. As described above, by assigning the calculation resources which have become surplus by thinning out the extraction and selection of rectangle to the object detection, the object detection can be applied to more rectangles, and improvement of object detection accuracy can be expected.

### Third Embodiment

In a third embodiment, the object detection processing shown in the first embodiment is pipelined to achieve the efficient object detection. Specifically, the object detection is performed from the frame at time point t+1 by using the rectangle extracted and selected from the frame at time point t. FIG. 12 is a diagram showing a flow of the processing. In this embodiment, a device capable of processing the inference of the deep learning model and other types of processing in parallel is required. By pipelining this processing, the standby time by the rectangle selection can be concealed, and the object detection can be applied to more rectangles as compared with the first embodiment and second embodiment, so that the detection accuracy can be improved and the application range of the present embodiment can be expanded.

### Fourth Embodiment

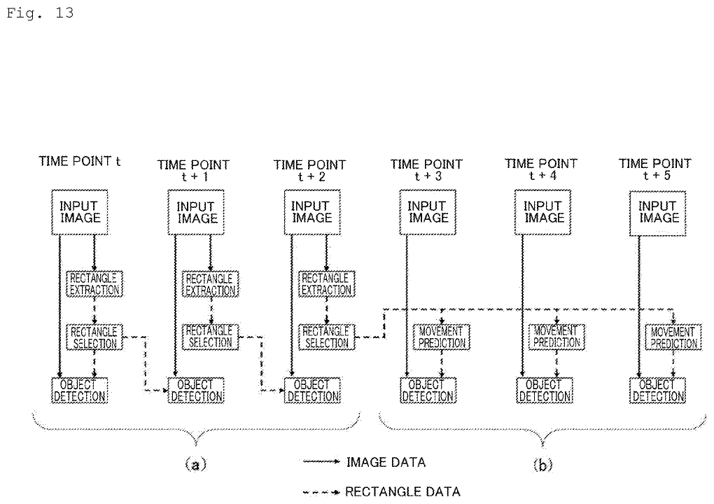

A fourth embodiment is an embodiment in which the second embodiment and the third embodiment which are described above are combined. That is, the object detection processing is performed while thinning out the processing of the rectangle extraction unit and the rectangle selection unit based on the fixed time interval or the decrease ratio of the object detection number, and when it is necessary to perform the object detection from the continuous frame, the inputted frame is efficiently processed by using the pipelined processing flow. FIG. 13 shows one example of the case where such processing is performed. In the segment where the rectangle is extracted and selected in each frame of (a), the pipelined processing flow is employed. In the segment where the extraction and selection of the rectangle are thinned out in (b), the movement prediction of the rectangle is performed. The extraction and selection of the rectangle are continuously performed from time point t to time point t+2, and the movement prediction of the rectangle is performed from time point t30 3 to time point t+5, and the extraction and selection of the rectangle are thinned out. At this time, the processing is pipelined to efficiently extract and select the rectangle and to perform the object detection from time point t to time point t+2. Thus, the processing utilizing the advantages shown in the second embodiment and third embodiment can be realized. That is, while appropriately thinning out the extraction and selection of the rectangle to secure the calculation resources necessary for the object detection from more rectangles, and in a scene where the extraction and selection of the rectangle are necessary in the continuous frame, efficiency is improved by pipelining to reduce the standby time of hardware and the object detection processing can be applied to more rectangles, so that the detection accuracy is improved and the application is expanded.

As the thinning method of the extraction and selection processing of the rectangle in this embodiment, any of the methods shown in the second embodiment is used. In addition, the frame number for performing the extraction and selection of the rectangle can be arbitrarily set, and when the conditions of the thinning processing are not satisfied, the extraction and selection of the rectangle can be performed again by an arbitrary frame number. In this way, the object detection device can have a pipelined processing mechanism so that the rectangle obtained by the processing in the rectangle extraction unit 110 and the rectangle selection unit 112 with respect to the frame inputted at time point t−1 is applied to the frame inputted at time point t and the processing in the object detection unit 114 is executed. Further, the object detection device can also be made to perform the processing by combining the processing of the rectangle extraction unit 110 and rectangle selection unit 112 by the thinning judgement unit 210 with the method of pipelining the processing of each processing unit.

Note that, the object detection processing executed by the CPU reading the software (program) in each above-mentioned embodiment may be executed by various processors other than the CPU. As examples of processors used in such case, a dedicated electric circuit that is a processor having a circuit configuration designed to execute specific processing such as a PLD (Programmable Logic Device) whose circuit configuration can be changed after production such as an FPGA (Field-Programmable Gate Array), a GPU, an ASIC (Application Specific Integrated Circuit), and the like are exemplified. In addition, the object detection processing may be performed by one of these various processors or may be performed by a combination of two or more of the same type or different types of the processors (for example, a plurality of FPGAS, a combination of the CPU and the FPGA, or the like). Further, the hardware structure of these various processors is more specifically an electric circuit combining circuit elements such as semiconductor elements.

Furthermore, the above-mentioned respective embodiments describe an aspect in which the object detection program is stored (installed) in advance in the storage 14, but the provision of the program is not limited to this aspect. The program may also be provided in a state where the program is stored in a non-transitory storage medium such as a CD-ROM (Compact Disk Read Only Memory), a DVD-ROM (Digital Versatile Disk Read Only Memory), or a USB (Universal Serial Bus) memory. Also, the program may be downloaded from an external device via a network.

The following additional items are disclosed related to the embodiments described above.

### (Additional Item 1)

An object detection device includes a memory and at least one processor connected to the memory, wherein

the processor is configured to

extract a plurality of rectangles to be candidates to which object detection is applied from an input image,

select a fixed number of rectangles to which the object detection is applied from among the extracted rectangle candidates, and

perform the object detection on the selected rectangle to output metadata including at least a class, reliability, and a bounding box of the object included in the input image as an object detection result.

### (Additional Item 2)

A non-transitory storage medium storing a program executable by a computer so as to execute object detection processing extracts a plurality of rectangles to be candidates to which object detection is applied from an input image,

selects a fixed number of rectangles to which the object detection is applied from among the extracted rectangle candidates, and

performs the object detection on the selected rectangle to output metadata including at least a class, reliability, and a bounding box of the object included in the input image as an object detection result.

1. An object detection device comprising:
a memory; and
at least one processor coupled to the memory, the at least one processor being configured to:
configured to extract a plurality of rectangles to be candidates to which object detection is applied from an input image;
configured to select a fixed number of rectangles to which the object detection is applied from among the rectangle candidates extracted; and
configured to perform the object detection on the rectangle selected to output metadata including at least a class, reliability, and a bounding box of the object included in the input image as an object detection result.

2. The object detection device according to claim 1, wherein a means of selecting the rectangle is any of a means of selecting the rectangle on the basis of an overlap degree between a distribution estimation result obtained and a rectangle selected in the past input image, a means of selecting the rectangle on the basis of an object detection result obtained from the past input image, a means of selecting the rectangle on the basis of a image difference from the past input image, and a means of selecting the rectangle included in the section while the input image is divided into a plurality of sections and the section is cyclically selected, or a combination of a plurality of means to select the rectangle.

3. The object detection device according to claim 1, further comprising:
configured to judge whether or not to execute processing in rectangle extraction and rectangle selection by a predetermined method, to apply the rectangle obtained by executing the processing of rectangle extraction and rectangle selection in a previously inputted frame to a current frame, and to thin out the processing.

4. The object detection device according to claim 3, wherein
thins out the processing of rectangle extraction and rectangle selection by using any or both of a means of realizing the thinning processing by not performing the processing in rectangle extraction and rectangle selection for a fixed time set in advance and a means of realizing the thinning processing by thinning out the processing of rectangle extraction and rectangle selection the object detection number in a predetermined frame becomes equal to or less than a predetermined rate in comparison with the detection number of objects in the frame in which the rectangle is extracted and selected.

5. The object detection device according to claim 1, comprising:
a pipelined processing mechanism configured to apply the rectangles obtained by the processing in rectangle extraction and rectangle selection in a frame inputted at time point t-1 to a frame inputted at time point t and to perform processing in object detection.

6. The object detection device according to claim 3, wherein
the thinning judgement unit performs processing by combining processing of thinning out the processing of rectangle extraction and rectangle selection and a method of pipelining processing of each processing.

7. An object detection method causing a computer to perform processing, the object detection method comprising:
extracting a plurality of rectangles to be candidates to which object detection is applied from an input image;
selecting a fixed number of rectangles to which the object detection is applied from among the extracted rectangle candidates; and
performing the object detection on the selected rectangle to output metadata including at least a class, reliability, and a bounding box of the object included in the input image as an object detection result.

8. A non-transitory, computer-readable storage medium storing an object detection program causing a computer to perform processing, the object detection program comprising:
extracting a plurality of rectangles to be candidates to which object detection is applied from an input image;
selecting a fixed number of rectangles to which the object detection is applied from among the extracted rectangle candidates; and
performing the object detection on the selected rectangle to output metadata including at least a class, reliability, and a bounding box of the object included in the input image as an object detection result.
